(19) United States
(12) Patent Application Publication
(10) Pub. No.: US 2021/0384854 A1
(43) Pub. Date: Dec. 9, 2021

(54) ELECTROMAGNETIC INDUCTION POWER GENERATOR

(71) Applicant: TDK Corporation, Tokyo (JP)

(72) Inventors: Yoshinobu TAKAYANAGI, Tokyo (JP); Tetsuya CHIBA, Tokyo (JP); Kazunori ISHIBASHI, Tokyo (JP)

(21) Appl. No.: 17/288,758

(22) PCT Filed: Sep. 24, 2019
(86) PCT No.: PCT/JP2019/037253

§ 371 Date: Apr. 26, 2021

(30) Foreign Application Priority Data
Nov. 8, 2018 (JP) 2018-210457

(51) Int. Cl. H02P 9/38; H02K 19/26

(52) U.S. Cl. CPC H02P 9/38; H02K 19/26

(57) ABSTRACT

An electromagnetic induction power generator includes: a current transformer attached to a power transmission line; a rectifier circuit for rectifying an AC voltage output from the current transformer; and a regulator circuit for regulating a DC voltage output from the rectifier circuit. The current transformer has a magnetic core attached to the power transmission line serving as a primary winding and a secondary winding magnetically coupled to the power transmission line through the magnetic core. The magnetic core is configured to start to be magnetically saturated around the minimum value within the fluctuation range of a current flowing through the power transmission line.

### TECHNICAL FIELD

The present invention relates to an electromagnetic induction power generator and, more particularly, to an electromagnetic induction power generator suitably used as a power supply for an IoT (Internet of Things) device attached to a power transmission line.

### BACKGROUND ART

There are known IoT devices that are attached to a power transmission line to monitor the state of the power transmission line. For example, Patent Document 1 describes a vibration detection device for detecting abnormal vibration of a power transmission line. The vibration detection device uses, as a power supply therefor, a power generator using electromagnetic induction caused by a change in a magnetic field generated around the power transmission line or a solar power generator.

Patent Document 2 describes a monitoring camera system using a power supply of an electromagnetic induction type. The monitoring camera system is detachably attached to a power transmission/distribution line and has a power generation CT core that generates power by an electromagnetic induction system, a power conversion part that converts an AC power generated from the power generation CT core into a DC power, a camera module for capturing a moving image, and a wireless communication module that externally transmits the captured data from the camera module.

### CITATION LIST

### Patent Document

[Patent Document 1] JP 2007-93342A

[Patent Document 2] JP 2016-517261A

### SUMMARY OF THE INVENTION

### Problem to be Solved by the Invention

A current flowing through a power transmission line significantly fluctuates depending on power demand. To make the IoT device operate stably despite fluctuation in the current flowing through the power transmission line, it is necessary to make an electromagnetic induction power generator always generate a minimum necessary power that enables the IoT device to operate even when the current flowing through the transmission line is minimum.

In the electromagnetic induction power generator that generates power using the current flowing through the power transmission line, a secondary current increases with an increase in the current flowing through the transmission line since energization time of the current flowing through the transmission line cannot be changed. Thus, when a very large current flows through the transmission line, power to be generated also becomes very large. Assuming that the IoT device operates with constant power consumption even though the power generation amount thus increases, a large amount of surplus power is generated. Thus, there occurs a necessity of consuming this surplus power in some way, such as conversion into heat.

However, the conversion of the surplus power into heat leads to an unnecessary temperature rise in the IoT device, which may accelerate degradation of components or elements constituting the IoT device. Further, a large current of several thousands of amperes or more may flow through a high-voltage power transmission line and, in this case, it is extremely difficult to convert all the surplus power generated by the large current into heat. Furthermore, when the IoT device is used on an overhead power transmission line, the installation and maintenance thereof are very difficult, so that IoT devices installed on such a location are required to operate stably for a long period of time of, e.g., 10 years or more from the installation. Considering this, it is desirable to minimize degradation in characteristics of the IoT device due to high temperature or the like.

It is therefore an object of the present invention to provide an electromagnetic induction power generator capable of generating a desired level of power even when a small current flows through the power transmission line and suppressing generation of a surplus power as much as possible when a large current flows through the power transmission line.

### Means for Solving the Problem

To solve the above problem, an electromagnetic induction power generator according to the present invention includes: a current transformer attached to a power transmission line serving as a primary winding; a rectifier circuit for rectifying an AC voltage output from the current transformer; and a regulator circuit for regulating a DC voltage output from the rectifier circuit. The current transformer has a magnetic core attached to the power transmission line and a secondary winding magnetically coupled to the power transmission line through the magnetic core. The magnetic core is configured to start to be magnetically saturated around the minimum value within the fluctuation range of a current flowing through the power transmission line.

According to the present invention, a desired level of power can be generated even when a primary current flowing through the transmission line is very small, allowing power to be stably supplied to an IoT device. Further, when the primary current is very large, an increase in an output voltage from the secondary winding is not proportional to the primary current, thereby suppressing an increase in the output voltage, so that it is possible to suppress generation of a surplus power and thus to prevent an unnecessary temperature rise caused by conversion of the surplus power into heat. This can prevent degradation in the performance, etc., of the IoT device.

In the present invention, the minimum value within the fluctuation range of the current flowing through the power transmission line is preferably 10 A or more to 100 A or less, more preferably, 30 A or more to 70 A or less, and particularly preferably, 40 A or more to 50 A or less. The maximum value within the fluctuation range is preferably 800 A or more, and particularly preferably 1080 A or more. The thus very wide fluctuation range of the current flowing through the power transmission line and generation of an output voltage in proportion to the primary current cause an extremely large output voltage to be generated from the current transformer, making it extremely difficult to handle a surplus power. However, in the present invention, generation of the surplus power is suppressed, so that it is possible to avoid the problem of heat generation due to the surplus power.

In the present invention, the magnetic core is preferably an annular core made of ferrite, and the power transmission line preferably passes through the hollow portion of the annular core. When the magnetic core is made of ferrite, degradation in magnetic characteristics due to aging originated from oxidation can be suppressed as compared to when the magnetic core is made of other magnetic materials such as a silicon steel plate. Thus, it is possible to maintain reliability for a long period of time of, e.g., 10 years or more and thus to use a current transformer using this magnetic core in an appropriate state under an environment where maintenance is difficult to perform.

In the present invention, it is preferable to determine the cross-sectional area of the magnetic core such that the magnetic core starts to be magnetically saturated around the minimum value of the fluctuation range of the current flowing through the power transmission line. When the width of selection of magnetic characteristics of the magnetic core is narrow, the magnetic saturation characteristics can be adjusted mainly based on the cross-sectional area of the magnetic core.

In the present invention, the power transmission line is preferably an overhead power transmission line and, particularly preferably a high-voltage power transmission line that feeds power at 66 kV or more. In the case of such a high-voltage overhead power transmission line, installation and maintenance of the IoT device are extremely difficult, so that the effect of the present invention is remarkable.

### Advantageous Effects of the Invention

According to the present invention, there can be provided an electromagnetic induction power generator capable of generating a desired level of power even when a small current flows through the transmission line and suppressing generation of a surplus power as much as possible when a large current flows through the transmission line.

### BRIEF DESCRIPTION OF DRAWINGS

FIG. 1 is a view illustrating the configuration of an electromagnetic induction power generator according to an embodiment of the present invention.

FIG. 2 is a schematic cross-sectional view illustrating the structure of the current transformer.

FIG. 3 is a graph illustrating the B-H curve of a magnetic material constituting the magnetic core.

### MODE FOR CARRYING OUT THE INVENTION

Preferred embodiments of the present invention will be explained below in detail with reference to the accompanying drawings.

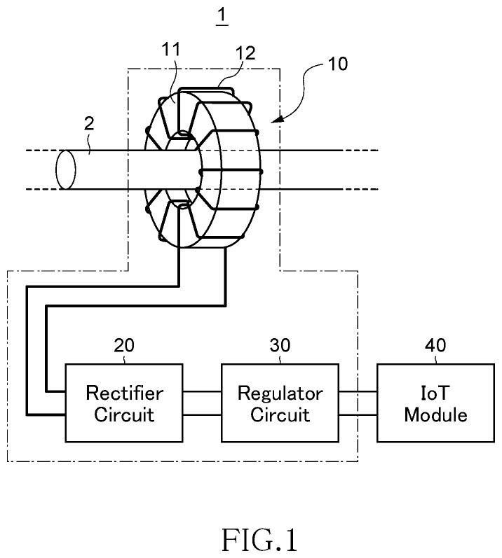

FIG. 1 is a view illustrating the configuration of an electromagnetic induction power generator according to an embodiment of the present invention.

As illustrated in FIG. 1, an electromagnetic induction power generator 1 has a current transformer 10 attached to a power transmission line 2, a rectifier circuit 20 for rectifying AC voltage output from the current transformer 10, and a regulator circuit 30 for regulating DC voltage output from the rectifier circuit 20. The electromagnetic induction power generator according to the present embodiment serves as a power supply for an IoT device, and an IoT module 40 is connected to an output terminal of the regulator circuit 30. The IoT module 40 is not particularly limited in type and may be any of various sensor modules that can measure the physical or electrical state of the power transmission line 2 or a remote monitor camera, etc. The IoT module 40 has a communication function and thus can transmit data collected by the sensor or camera to a server.

The power transmission line 2 is preferably an overhead power transmission line and, more preferably, a high-voltage power transmission line that feeds power at 66 kV or more. In this case, the effect of the present invention is remarkable. This is because the overhead power transmission line is installed at a high location not lower than several tens of meters from the ground, so that installation and maintenance of the IoT device are extremely difficult, and the fluctuation range of the current flowing through this power transmission line 2 is wide. An AC current with a commercial frequency (50 Hz or 60 Hz) flows through the power transmission line 2, and an alternating magnetic field is generated around the power transmission line 2. The magnitude of the alternating magnetic field changes depending on the magnitude of the current flowing through the power transmission line 2.

The current transformer 10 has a magnetic core 11 attached to the power transmission line 2 as a primary winding and a secondary winding 12 magnetically coupled to the power transmission line 2 through the magnetic core 11. The magnetic core 11 is, e.g., a divided toroidal core and is attached to the power transmission line 2 so as to allow the power transmission line 2 to pass through the hollow portion of the toroidal core. The secondary winding 12 is wound around the toroidal core in a predetermined number of turns, and a pair of input terminals of the rectifier circuit 20 are connected to both ends of the secondary winding 12. The magnetic core 11 is not limited to a circular toroidal core but may be a polygonal annular core such as a rectangular core.

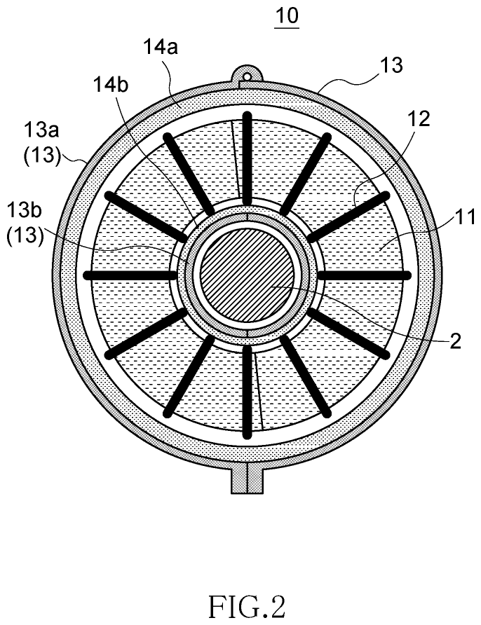

FIG. 2 is a schematic cross-sectional view illustrating the structure of the current transformer 10. As illustrated, the current transformer 10 is preferably installed on the power transmission line 2 in a state of being housed in a metal case 13 such as an aluminum case. In this case, the power transmission line 2 contacts the metal case 13, and the metal case 13 is electrically connected to the power transmission line 2; however, the current transformer 10 housed in the metal case 13 is insulated and isolated from an outer shell 13a and an inner shell 13b of the metal case 13 through insulators 14a and 14b. The secondary winding 12 is insulation-coated to ensure an insulation state between the magnetic core 11 and the secondary winding 12.

In the present embodiment, the magnetic material constituting the magnetic core 11 is preferably ferrite. It is because ferrite is a ferromagnetic material mainly composed of iron oxide and is originally oxidized, so that it is less subject to a change in magnetic characteristics due to aging such as oxidation than other magnetic materials such as a silicon steel plate. It is because that the IoT device that has been attached to the power transmission line 2 is extremely difficult to repair and replace and is thus required to operate stably over a long period of time of, e.g., 10 years or more and to be less subject to aging. In a low frequency region, the silicon steel plate has better magnetic characteristics than ferrite, so that the magnetic core can be miniaturized when the silicon steel plate is used. However, considering a reduction in reliability due to aging, ferrite is advantageous over the silicon steel plate.

The current flowing through the power transmission line 2 significantly fluctuates depending on power demand from a value as very small as about 50 A to a value as extremely large as 1080 A or more. On the other hand, to make the IoT device operate in a constantly stable manner, it is necessary not only to allow a desired level of power generation at the minimum value of the current flowing through the power transmission line 2 but also to prevent a surplus power from being generated even when the current flowing through the power transmission line 2 becomes large. It is because when the output voltage increases in proportion to a primary current, a very large surplus power is generated. For example, when the minimum value of the primary current is 50 A, the output voltage when the primary current is 1080 A becomes 21 times or more the output voltage when the primary current is minimum. When such a surplus current is converted into heat and released, the temperature of the entire IoT device including the power supply increases, causing acceleration of aging.

Thus, the magnetic core 11 of the current transformer 10 according to the present embodiment is configured to start to be magnetically saturated around the minimum value within the fluctuation range of the current flowing through the power transmission line 2 and to suppress an increase in the output voltage from the secondary winding 12 even with an increase in the current flowing through the power transmission line 2. In a case where the magnetic core 11 is thus magnetically saturated around the minimum value within the fluctuation range of the current flowing through the power transmission line 2, further increase in the current flowing through the power transmission line 2 does not increase magnetic flux in the magnetic core 11 in proportion to the primary current and causes almost no increase in the output voltage induced in the secondary winding 12, thus making it possible to prevent a surplus power from being supplied to the IoT module 40.

The minimum value within the fluctuation range of the current flowing through the power transmission line 2 is preferably 10 A or more to 100 A or less, more preferably, 30 A or more to 70 A or less, and particularly preferably, 40 A or more to 50 A or less. On the other hand, the maximum value within the fluctuation range of the current flowing through the power transmission line 2 is 800 A or more and, preferably, 1080 A or more. The thus very wide fluctuation range of the current flowing through the power transmission line 2 and generation of an output voltage in proportion to the primary current cause an extremely large output voltage to be generated by the current transformer 10, making it extremely difficult to handle a surplus power. However, generation of a surplus power can be suppressed under the condition that the magnetic core 11 is magnetically saturated, so that it is possible to avoid the problem of heat generation.

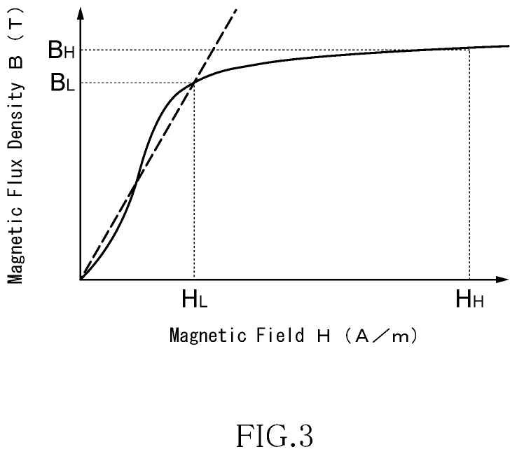

FIG. 3 is a graph illustrating the B-H curve of a magnetic material constituting the magnetic core 11.

As illustrated in FIG. 3, a relation expression of B=μH is satisfied between the magnetic field H and the magnetic flux density B when the magnetic core 11 is not magnetically saturated, and the magnetic flux density B is proportional to the magnetic field H as denoted by the dashed line in the graph. Actually, however, as denoted by the solid line, the magnetic flux density B is not proportional to the magnetic field H. Since the magnetic field H is proportional to a primary current I, the solid line represents that a permeability μ decreases in proportion to the primary current I.

That is, as a result of an increase in the primary current I (magnetic field H), the magnetic flux density B reaches the maximum magnetic flux density of the magnetic material thereof and does not increase any further. A state in which a change in the magnetic flux density B is very small corresponds to the state of magnetic saturation.

In the present embodiment, the material (permeability) or cross-sectional area of the magnetic core 11 is selected such that the magnetic core 11 is substantially brought into a magnetic saturation state when the primary current I flowing through the power transmission line 2 is at the minimum value within its fluctuation range, and the number of turns of the secondary winding 12 is calculated. By doing so, it is possible to prevent the electromagnetic induction power generator 1 from generating a surplus power even with an increase in the primary current.

The magnitude of the magnetic field H (magnetomotive force) is proportional to the cross-sectional area or permeability of the magnetic core 11. That is, increasing the cross-sectional area of the magnetic core 11 increases the magnetomotive force H, and increasing the permeability μ of the magnetic core 11 increases the magnetomotive force H. Thus, adjusting the cross-sectional area or permeability μ of the magnetic core 11 allows adjustment of the magnetic saturation characteristics of the magnetic core 11, whereby it is possible to make the magnetic core 11 start to be magnetically saturated when the current flowing through the power transmission line 2 is at the minimum value (e.g., 50 A) within its fluctuation range defined with respect to the power transmission line 2.

In the present embodiment, it is particularly preferable to determine the cross-sectional area of the magnetic core 11 such that the magnetic core 11 starts to be magnetically saturated around the minimum value of the fluctuation range of the current flowing through the power transmission line 2. When ferrite is used for the magnetic core 11, the width of selection of magnetic characteristics is narrow, allowing the magnetic saturation characteristics to be adjusted based on the cross-sectional area of the magnetic core 11.

The magnetomotive force of the magnetic core 11 when the current flowing through the power transmission line 2 is at the minimum value (e.g., 50 A) within its fluctuation range is assumed to H_{L}, the magnetomotive force of the magnetic core 11 when the current flowing through the power transmission line 2 is at the maximum value (e.g., 1200 A) within its fluctuation range is assumed to H_{H}, and the magnetic core 11 is assumed to start to be magnetically saturated when the magnetomotive force is H_{L}. The magnetic flux density of the magnetic core 11 when the magnetomotive force is H_{L} is B_{L}, and the magnetic flux density of the magnetic core 11 when the magnetomotive force is H_{H} is B_{H}. Although the magnetomotive force H_{H} is 24 times the magnetomotive force H_{L}, the magnetic flux density B_{H} can be reduced to a value equal to or less than twice the magnetic flux density B_{L} since the magnetic core 11 is magnetically saturated. That is, an output voltage Vo when the primary current I is at the maximum value can be reduced to a value equal to less than twice an output voltage Vo when the primary current I is at the minimum value. The value of this voltage level can be controlled by the regulator circuit 30, and thus generation of a surplus power can be suppressed.

As described above, the electromagnetic induction power generator 1 according to the present embodiment includes the current transformer 10 attached to the power transmission line 2 as the primary winding, and the magnetic core 11 of the current transformer 10 is configured to start to be magnetically saturated around the maximum value within the fluctuation range of the current flowing through the power transmission line 2. This makes it possible to suppress an increase in the output voltage induced in the secondary winding 12 and thus to suppress generation of a surplus power that cannot be completely consumed by the IoT device.

While the preferred embodiments of the present invention have been described, the present invention is not limited to the above embodiments, and various modifications may be made within the scope of the present invention, and all such modifications are included in the present invention.

For example, although a case where the IoT device is installed on the overhead power transmission line has been taken as a preferred example in the above embodiment, the present invention is not limited to this, but the IoT device may be installed on power transmission lines of other types such as an underground power transmission line. However, the overhead power transmission line carries a very large current and is thus significantly affected by a surplus power, and further, the installation of the IoT device on the overhead power transmission line and the maintenance of the IoT device that has been installed on the power transmission line are very difficult. Thus, in a case where the IoT device is installed on the overhead power transmission line, the effect of the present invention is remarkable.

### REFERENCE SIGNS LIST

1 electromagnetic induction power generator
2 power transmission line
10 current transformer
11 magnetic core
12 secondary winding
13 metal case
13a outer shell of metal case
13b inner shell of metal case
14a, 14b insulator
20 rectifier circuit
30 regulator circuit
40 IoT module

1. An electromagnetic induction power generator comprising:
a current transformer attached to a power transmission line serving as a primary winding;
a rectifier circuit for rectifying an AC voltage output from the current transformer; and
a regulator circuit for regulating a DC voltage output from the rectifier circuit,
wherein the current transformer has a magnetic core attached to the power transmission line and a secondary winding magnetically coupled to the power transmission line through the magnetic core, and
wherein the magnetic core is configured to start to be magnetically saturated around a minimum value within a fluctuation range of a current flowing through the power transmission line.

2. The electromagnetic induction power generator as claimed in claim 1, wherein the minimum value within the fluctuation range of the current flowing through the power transmission line is 10 A or more to 100 A or less.

3. The electromagnetic induction power generator as claimed in claim 1, wherein the magnetic core is an annular core made of ferrite, and the power transmission line passes through a hollow portion of the annular core.

4. The electromagnetic induction power generator as claimed in claim 3, wherein a cross-sectional area of the magnetic core is determined such that the magnetic core starts to be magnetically saturated around the minimum value of the fluctuation range of the current flowing through the power transmission line.

5. The electromagnetic induction power generator as claimed in claim 1, wherein the power transmission line is an overhead power transmission line.

6. The electromagnetic induction power generator as claimed in claim 2, wherein the magnetic core is an annular core made of ferrite, and the power transmission line passes through a hollow portion of the annular core.
